(19) United States
(12) Patent Application Publication
(10) Pub. No.: US 2026/0090515 A1
(43) Pub. Date: Apr. 2, 2026

(54) Weight-Based Multiple Pet Food Access Control System

(71) Applicant: George Joseph Steinmetz, III, Lewiston, NY (US)

(72) Inventor: George Joseph Steinmetz, III, Lewiston, NY (US)

(21) Appl. No.: 19/413,908

(22) Filed: Dec. 9, 2025

Related U.S. Application Data
(60) Provisional application No. 63/897,639, filed on Oct. 11, 2025.

(51) Int. Cl. A01K 5/02

(52) U.S. Cl. CPC A01K 5/0233

(57) ABSTRACT

The Weight-Based Multiple Pet Food Access Control System is a programmable apparatus comprising hardware and software components that regulate access to pet food bowls based on measured mass. The system utilizes load cell sensors to detect the weight of an animal (e.g., cat, small dog) positioned on a designated platform. Based on pre-defined weight thresholds, the system determines which of one or more servo-actuated apertures to open, thereby granting access to a specific food bowl. Each aperture is configured to respond to a particular weight range and automatically closes when the detected weight falls outside the assigned range. This enables selective feeding in multi-pet environments, ensuring that each animal accesses only its designated food source.

### BACKGROUND OF THE INVENTION

Most pet access control systems (commonly marketed as “pet feeders”) rely on unique radio frequency identification (RFID) transmitters assigned to each pet. These transmitters may take the form of a tag attached to the pet's collar or utilize the pet's embedded RFID chip, typically placed by a veterinarian in the subcutaneous layer of skin near the dorsal region of the neck. However, these approaches present several limitations:
Some pets do not tolerate collars.
Embedded RFID chips may be difficult to read reliably.

Alternative systems use cameras for pet recognition, but these can be problematic when multiple pets have similar appearances (e.g., littermates) or when the pet owner prefers not to install cameras in living areas. Additionally, systems that incorporate artificial intelligence (AI) for pet identification may raise privacy concerns for users who are uncomfortable with automated surveillance technologies in domestic spaces.

Despite these challenges, per-pet access control remains necessary in many situations—for example, when one pet is on a weight-control regimen or requires specialized food that should only be consumed by that specific animal. Likewise, pets with dietary restrictions may need to be prevented from accessing standard pet food intended for other animals in the household.

### BRIEF SUMMARY OF THE INVENTION

The Weight-Based Multiple Pet Food Access Control System (hereafter referred to as “the invention” or “the system”) comprises a scale platform that pets must stand on to access food bowls. As a pet steps onto the scale, its weight is measured and compared against a set of pre-programmed weight ranges. If the detected weight falls within the range assigned to a specific aperture, the corresponding servo mechanism activates, opening that aperture to reveal the designated food bowl beneath.

In households with multiple pets, the system may be configured to respond to simultaneous presence—opening one, both, or neither of the apertures based on the programmed dietary requirements and access permissions for each pet. The dual-open configuration helps reduce behavioral conflict, such as one pet attempting to access another's food or exhibiting distress when their own bowl remains closed. Once all pets have vacated the scale, the system automatically closes all apertures, securing the food bowls until the next access event.

The dual-open configuration can also be manually selected through a variety of interfaces, including but not limited to: toggle switch, push button, Amazon Alexa integration, web page, or Telnet connection. This manual activation is intended to facilitate refilling of the food bowls without requiring their physical removal and re-insertion.

Although the included examples describe a two-bowl system for small household pets, the invention may be constructed in a variety of configurations. These include adjustments to the number and size of bowls or covers, the choice of construction materials—such as polymers for domestic use or metals for livestock—and the selection of load cells with appropriate weight-detection ranges to accommodate animals of varying sizes.

### BRIEF DESCRIPTION OF THE DRAWINGS

FIG. 1 is a top-down view of the complete system, showing the electronics cover and controls, food bowl apertures and servo mechanisms, and the scale.

FIG. 2 is a bottom view of the system, showing the scale's load cell electronics, the base that holds the servos, bowls, apertures, and main electronics, and the cable interconnecting the scale and main electronics.

FIG. 3A is a forward-facing view, showing the servos, apertures, bowls, scale, and base.

FIG. 3B is a rear-facing view, showing the servos, electronics cover and controls, and the base, along with partial views of the servos, apertures, and bowls.

FIG. 3C is a close-up side view of one of the aperture assemblies, showing the servo, gears, and elevated supports.

FIG. 4A is a front diagonal view.

FIG. 4B is a rear diagonal view.

FIG. 5A is an exploded view of the electronics cover, servos, apertures, bowls, and electronics.

FIG. 5B is an exploded view of the supports and standoffs, the base and scale, load cell mounts, silicone feet, load cells, and cables.

FIG. 6 is a wiring diagram of the system's hardware, showing general component connections with common positive and negative leads removed for clarity.

FIG. 7 is a hardware layout diagram showing general component placement with all wiring removed for clarity.

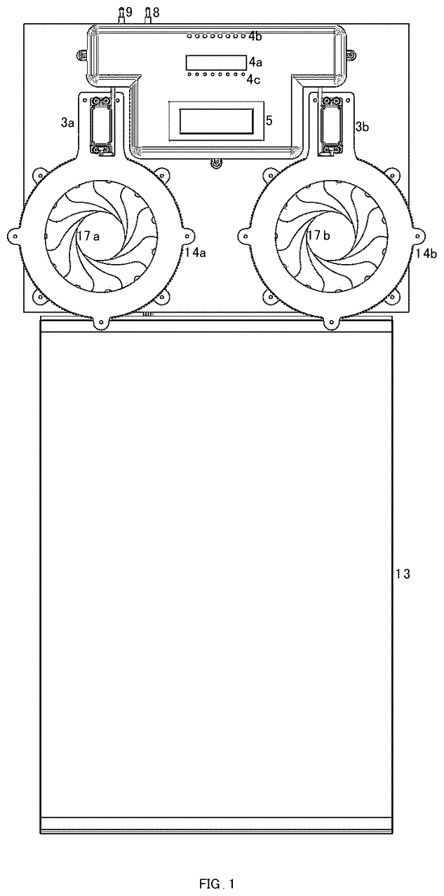

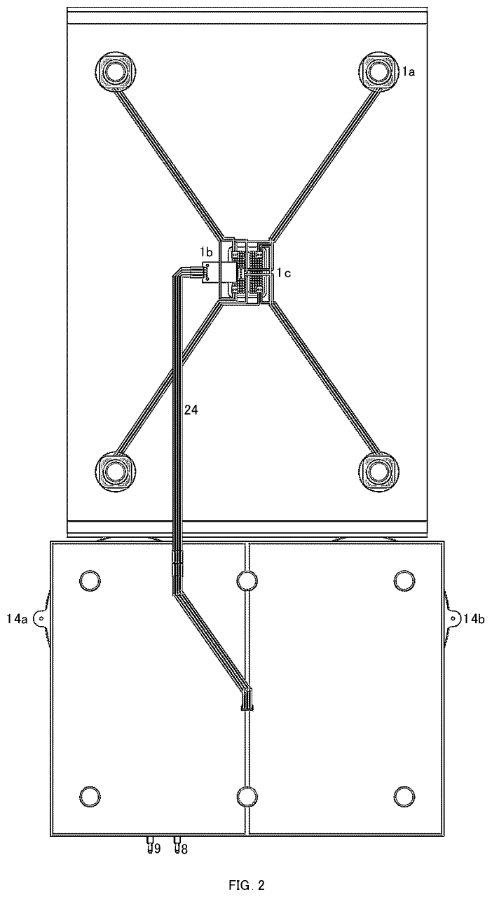

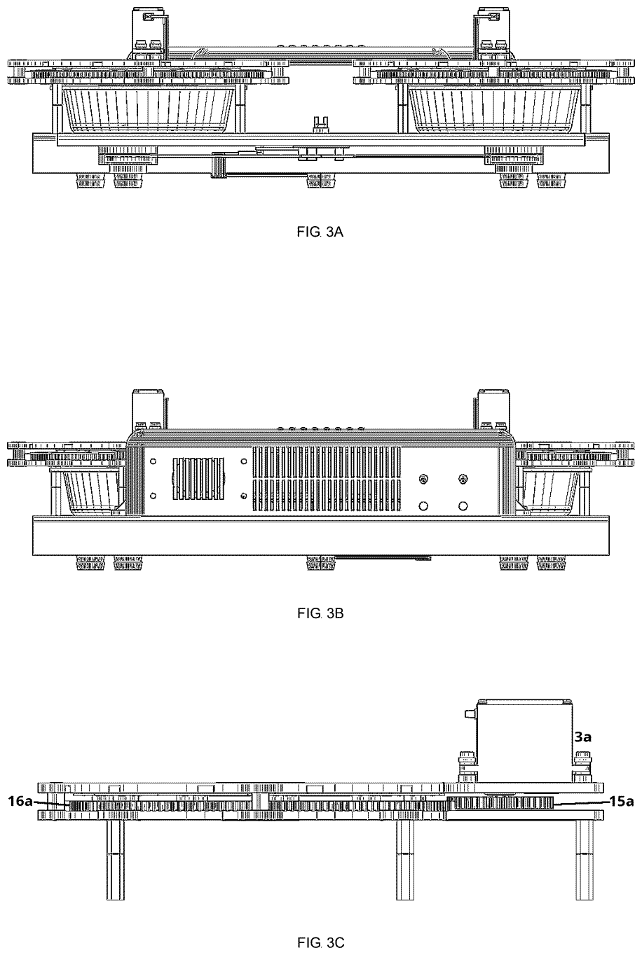

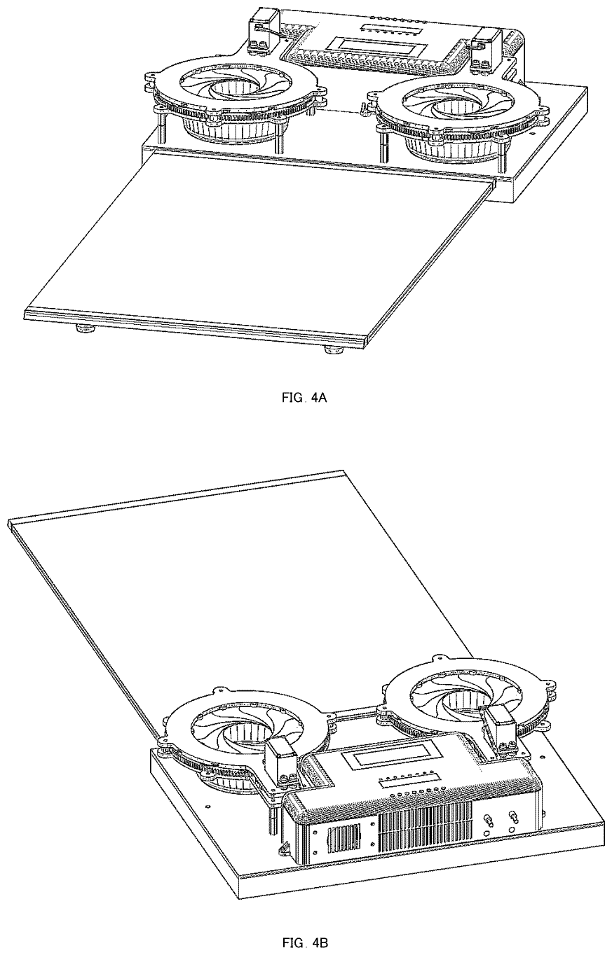

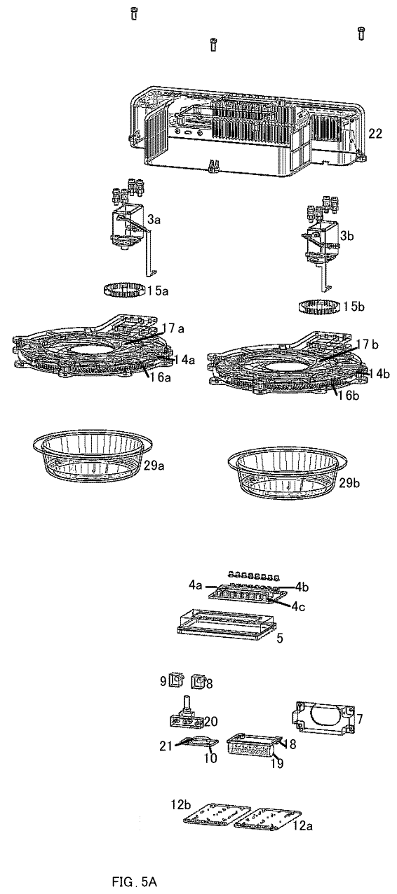

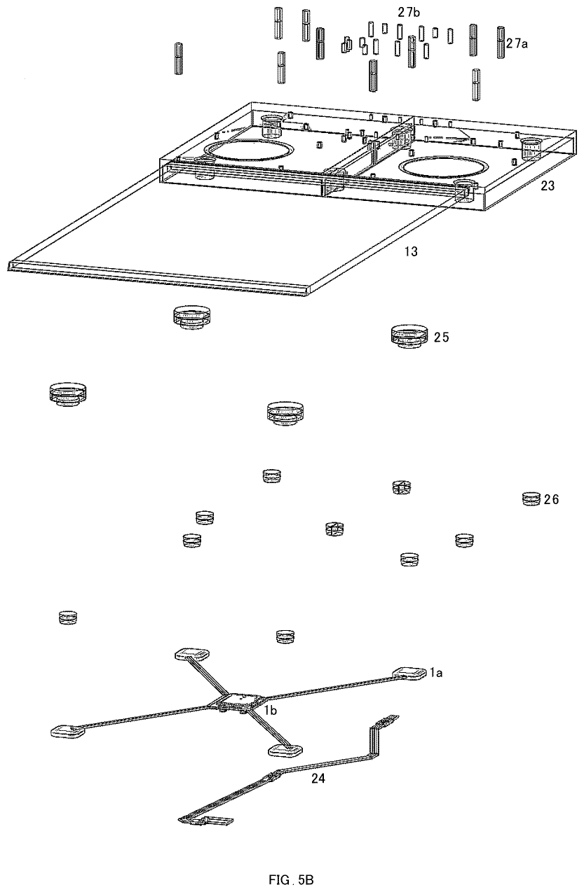

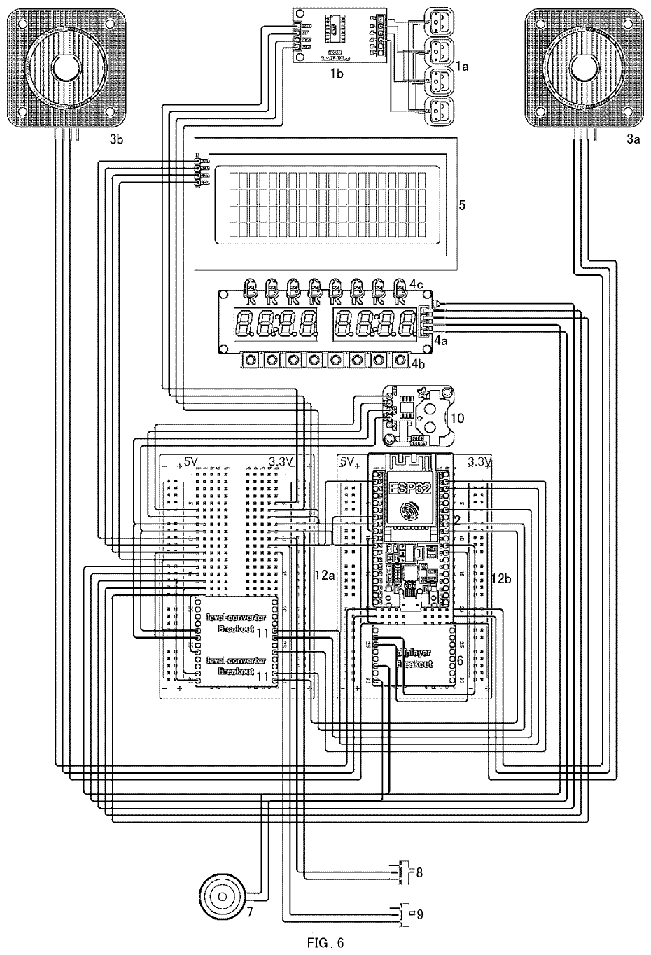

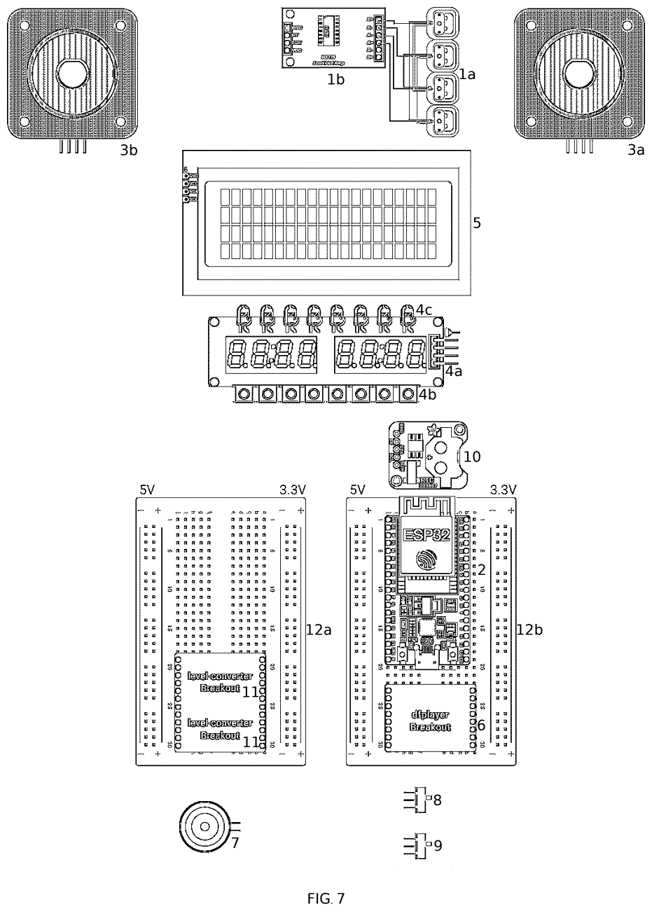

### LIST OF REFERENCE NUMBERS

### Mechanical Components

3a MG996R 360-degree servo (left)
3b MG996R 360-degree servo (right)
14a Food cover assembly 1 (left)
14b Food cover assembly 2 (right)
15a MG996R gear 1 (left)
15b MG996R gear 2 (right)
16a Aperture gear 1 (left)
16b Aperture gear 2 (right)
17a Aperture blades 1 (left)
17b Aperture blades 2 (right)

### Electrical Components

1a Load cells (four shown)
1b HX711 analog-to-digital converter (ADC) module and mini breadboard
1c Mini perfboard (load cells, HX711)
2 ESP32 microcontroller
6 DFPlayer Mini audio module
7 Speaker
10 DS3231 real-time clock (RTC) module
11 Logic level converter (two shown)
12a Half perfboard (left) (power supply, DS3231, LCD2004, TM1638, HX711, toggle switches)
12b Half perfboard (right) (ESP32, DFPlayer Mini, MG996Rs)
18 Power supply
19 Power supply battery
20 USB-C connection to power supply
21 CR2032 battery
24 Scale data cable

### Control Systems

4a TM1638 display and input module: Seven-segment LED displays with decimal points (eight shown)
4b TM1638 display and input module: Push buttons/momentary switches (eight shown)
4c TM1638 display and input module: Indicator LEDs (eight shown)
5 LCD2004 backlit liquid-crystal display
8 Toggle switch: Open/close all apertures
9 Toggle switch: ESP32 reset

### Structural Elements

13 Scale platform
22 Electronics cover
23 Base platform
25 Load cell mounts (four shown)
26 Silicone feet (ten stacks of two shown)
27a Large brass standoffs for food bowl covers (ten sets of two shown, two sets intentionally omitted to allow removal of bowls) (screws not shown)
28a Small brass and 3D-printed standoffs for mounting equipment to base (screws not shown)
29a Food bowl (left)
29b Food bowl (right)

### DETAILED DESCRIPTION OF THE INVENTION

### Core Function: Pet Detection/Opening Aperture

When the pet steps onto the scale platform (13), downward force is transmitted through the upper mount (25), compressing the load cell (1a) against the lower mount and silicone feet (26), which rest on the floor. This layered configuration ensures accurate weight detection and shock absorption. The pressure causes a voltage change, which is detected by the HX711 ADC module (1b). As the pet continues to walk onto the scale platform towards the fool bowls (29a and 29b), all four load cells—connected to the mini breadboard (1c) and wired in a Wheatstone bridge configuration—become compressed, averaging their voltages. The HX711 then sends the increasing weight readings along the data cable (24) to the left half perfboard (12a), which is wired to the right half perfboard (12b) and connected to general purpose input/output (GPIO) pins 32 (serial clock, SCK) and 33 (data, DT) of the ESP32 (2). In this embodiment, the ESP32 microcontroller is selected for its sufficient GPIO availability, integrated Wi-Fi, and compatibility with the included libraries; however, alternative microcontrollers or single-board computers may be used depending on system requirements.

Firmware running on the ESP32 (2) reads the digital signal from the HX711 (1b), converts it into grams, and continues sampling until the readings stabilize to under 25 grams per 100 microseconds (equivalent to 250 grams per second, measured in one-tenth-second increments). This delay allows the pet to fully step onto the scale platform (13), ensuring all four paws are registered and the full weight is measured. During this period, real-time weight readings are displayed on the LCD screen (5) and optionally on the seven-segment LED displays (4a), allowing visual confirmation of the stabilization process. The displays may include the raw value received from the HX711 (1b), the converted weight in hundredths of pounds, and the converted weight in hundredths of kilograms. In alternative embodiments, the display precision may be adjusted for clarity, debugging, or regional unit preferences.

While the system is described in the context of household pets, such as cats or small dogs, alternative embodiments may be adapted for other animals with varying limb configurations and weight profiles.

Once the weight is considered stable, it is compared against a list of weight ranges, resulting in one of the following classifications:
Less than the minimum weight of the lighter pet: no pets detected
Between the minimum and maximum weight of the lighter pet: pet 1 detected
Between the maximum weight of the lighter pet and minimum weight of the heavier pet: unknown weight detected
Between the minimum and maximum weight of the heavier pet: pet 2 detected
Between the maximum weight of the heavier pet and the combined maximum weights of both pets: both pets detected
Beyond the combined maximum weights of both pets: unknown weight detected

In another embodiment, the system includes secondary logic to resolve ambiguity when multiple pets have similar detected weights. If the weight detected at the start of a session is within a defined threshold of multiple known pet profiles, the system may use additional identification methods. One embodiment includes one or more photoelectric sensors positioned to measure the pet's physical dimensions, such as height, width, and depth, as the pet enters the feeding area. In another embodiment, the system uses optical sensors to detect surface reflectivity (albedo) and fur coloration patterns. These biometric features may be used to distinguish pets with similar weight and size profiles, enabling identification without requiring facial recognition or RFID.

The outcome is displayed on the LCD screen (5) via text and emoji. If a pet is detected, the ESP32 (2) activates GPIO pin 25 for the left food cover assembly (14a), or GPIO pin 26 for the right food cover assembly (14b). This signal drives the left (3a) or right (3b) MG996R 360-degree servo, rotating the corresponding 44-tooth gear (15a or 15b) clockwise for 1600 milliseconds. This motion engages the left (16a) or right (16b) approximately 154-tooth aperture gear, rotating it approximately 90 degrees to open the aperture from a mostly-closed state (approximately 10 percent open) to a fully-opened state, thereby exposing the food bowl (29a or 29b). The firmware logs the event to a data file, recording the current date and time in the user's local time zone, along with the weight of the detected pet. In alternative embodiments, the feeding aperture may be covered or uncovered using a sliding mechanism, such as a flat plane actuated by a rack and pinion gear system. This configuration may offer mechanical simplicity and reduced stress on components compared to rotating or iris-style mechanisms. In further embodiments, the cover may lift vertically via a hinge, providing access without lateral motion. While a sliding cover actuated by a rack and pinion mechanism was initially considered, the iris-style aperture was selected for its compact footprint, reduced spatial requirements, and mechanical containment above the bowl. This design minimizes enclosure size and avoids interference with rear-mounted components. In certain embodiments, a sliding door mechanism may be preferable in more industrial environments, where the relative complexity and potential fragility of an aperture-style system could increase the risk of mechanical damage or operational failure.

The aperture gear assembly (14a, 14b), which includes the aperture gear (16a, 16b) and aperture blades (17a, 17b), is a modified version of a 3D model originally downloaded from a publicly available STL repository. The original gear design was adapted to fit the MG996R servos (3a, 3b) by enlarging the servo mounting hole, creating a custom gear (15a, 15b) optimized for MG996R mounting and increased rotational speed, and adding structural tabs for secure attachment to the base platform (23). The aperture blades were thinned to ensure that the originally theoretical design could function reliably in physical implementation. An additional customization includes the use of six approximately 20 mm×0.8 mm×0.3 mm shims inside each custom MG996R gear to provide sufficient traction for driving the aperture gear, while allowing controlled slippage when fully opened (to prevent stalling) and fully closed (to reduce the risk of blade damage). In alternate embodiments, torque limiting may be achieved through more refined mechanisms, such as concentric gear assemblies featuring flexible extensions on the gear teeth. These extensions are configured to deform or slide under excess torque, allowing intentional slippage once a predefined torque threshold is reached. This design protects the cover and surrounding components from mechanical stress while maintaining reliable aperture operation, and reduces the risk of injury or trapping if a pet has part of its body inside the aperture during closure.

To install the shims, a single approximately 300 mm×0.8 mm×0.3 mm printed shim is threaded through the central hole of the custom MG996R gear and wrapped around its outer edge six times, spaced approximately 60 degrees apart. Once the gear is mounted, the excess shim material is trimmed near the top and bottom, leaving six evenly spaced traction points. This installation method ensures consistent engagement with the aperture gear while allowing controlled slippage at both the fully open and fully closed positions, preventing servo stalling and reducing the risk of blade damage.

The system continues monitoring the weight throughout the session, noting the maximum weight detected until either no pet is present or a new weight condition triggers a rule change. If the weight shifts from the lighter pet to the heavier one (one cause is the heavier pet stepping onto the scale platform (13) so slowly that it is detected as the lighter pet at first, then the heavier one), the system will close the left food cover (14a) and open the right one (14b). In addition, once the log file (see Data Recording) and LED display (4a) are updated at the end of the session, they will discard the false lighter pet reading and log only the heavier pet. The debug log will still show two entries: One at the time the lighter pet was falsely detected, and one at the time the heavier pet was detected. Additional embodiments of the firmware may include a timeout and cooldown threshold per pet, to discourage overeating.

Once the pet steps off the scale or the maximum feeding timeout is reached, a notification is displayed on the LCD screen (5) via text. The ESP32 (2) then sends a close signal via GPIO pin 25 or 26 to the left (14a) or right (14b) food cover assembly, activating the corresponding MG996R 360-degree servo (3a or 3b). This drives the 44-tooth gear (15a or 15b) counterclockwise for 1620 milliseconds. This motion engages the aperture gear (16a or 16b), rotating it approximately 90 degrees to transition the aperture from a fully-opened state to a mostly-closed state (approximately 10 percent open), thereby covering the food bowl (29a or 29b).

Due to the MG996R's operational characteristics and the increased torque required to close the aperture, this longer duration results in less rotational movement than the opening signal. This behavior is intentional: each opening action resets the aperture to a fully-open state, allowing controlled slippage between the servo's output shaft and the servo gear. This ensures that the closing action consistently returns the aperture to a mostly-closed state with a 10 percent opening, preventing cumulative over-closure that could otherwise force the blades past their mechanical limits, leading to buckling or dislocation. Once the aperture closes, the maximum detected weight is displayed on the LED display (4a) in its default configuration, and a second log file is appended. This file records the current date and time in the user's local time zone, the maximum weight detected during the session, and the total feeding duration of the detected pet.

Optional activities are performed at pet detection and end of session:
An emoji and two-line description of the pet detected and the activity taken, displayed on the LCD (5). The second line is replaced by the date and time once the open/close action is completed.
A one-line description of the pet detected can display on the LED (4a) depending on its mode.
An audio file can play on the speaker (7) via the DFPlayer Mini audio module (6).
Real-time weight in pounds and kilograms can display on the LED (4a) depending on its mode, throughout the entire session.

In another embodiment, the system includes a passive watchdog circuit comprising a resistor-capacitor timing network and a transistor or relay triggered by a GPIO signal. The capacitor charges over time and is periodically discharged by the GPIO signal. If the signal fails to arrive within a defined timeout period, the capacitor voltage rises, triggering the transistor or relay to pull the EN (enable/reset) pin low. This embodiment enables automatic reset functionality in the event of system lockup or microcontroller hang (e.g., ESP32), ensuring system reliability without requiring active software intervention. Other embodiments may opt to use software watchdogs instead of physical ones.

### Informational Displays/Outputs

The LCD2004 module (5) is configurable to display both live and historical data relevant to pet detection and system status, refreshing up to 10 times per second with each new weight reading. In its default configuration, the display presents the following information, but it can be modified to show additional information, such as temperature:
0.00 lb 226331??Cat mass: 0.00 kgNo cats detected. We 10/8/2025 9:13:38

Line 1: Current detected weight in hundredths of pounds, the raw value received from the HX711 module (1b), and a Wi-Fi signal strength indicator (represented with the ?? placeholder in this example). The signal strength is represented by 0 to 5 vertical bars of increasing height; if no connection is established, the indicator displays OFF.

Line 2: Current detected weight in hundredths of kilograms. The label (e.g., “Cat mass”) reflects the current configuration, which may be customized based on the assigned profiles. While the system supports multiple pets, including cats, dogs, or other animals, the displayed label adapts accordingly.

Line 3: An optional emoji character indicating the detected pet or current system status, followed by a descriptive text string.

Line 4: The current date and time, with the year displayed in either two-digit or four-digit format depending on available space. The system's current time and date are maintained by the DS3231 Real-Time Clock (RTC) module (10), powered by a CR2032 battery (21) to maintain persistent timekeeping across power cycles. On power-up, the firmware sets the ESP32 (2) internal clock using the RTC, activates a connection to the local Wi-Fi network, and—if successful—refreshes both the ESP32 and RTC clocks using Network Time Protocol (NTP) over the Internet.

The display may be modified to include additional information, such as ambient temperature, feeding history, or system alerts, depending on the selected configuration and available sensors.

The TM1638 7-segment LED module with decimal points (4a) can display a variety of information, adjustable via push buttons (4b), web interface, or Telnet connection. Displayed data may include, but is not limited to:
Last logged weight of two pets in tenths of pounds or tenths of kilograms
Live weight in tenths of pounds and tenths of kilograms
Raw data from HX711 module
current time, using decimals as hour/minute/second separators, in various custom regional formats such as 12-hour or 24-hour mode, with or without leading zeros for the hour
Current date, using decimals as year/month/day separators, in various custom regional formats, with or without leading zeros for the month or date, and with either a two-digit or four-digit year
IP address in dotted-decimal notation
RSSI Wi-Fi signal strength in decibels
Description of the pet currently detected, or a placeholder such as IDLE when no pet is detected. This can include effects such as alternating between bright and dim text. Since this embodiment uses 7-segment numeric displays, letters are represented in uppercase or lowercase depending on requirements. Where lowercase or certain characters are unavailable, substitutions may be used—such as “H” for “K,” or stylized glyphs for “W” and “M” to approximate intended letters. These adaptations preserve legibility and expressive intent within the constraints of 7-segment display hardware. Additional embodiments may incorporate 14-segment alphanumeric displays to enable true character representation.
Temperature in Fahrenheit and Celsius®
Last logged elapsed time of feeding of two pets in minutes and seconds, using decimals as minute/second separators

The DFPlayer Mini audio module (6) plays optional sound effects recorded on a microSD card through the mono speaker (7), providing audible notifications to indicate which pet has activated or deactivated the system. (Different embodiments may use alternative audio modules or stereo speakers.) Each pet has a unique set of alert sound effects stored as audio files, organized in a file format and folder structure dictated by the audio module manufacturer. These audio files may include informative alerts, humorous sound effects, or music clips, depending on the preferences of the system's users or pet owners. The number of saved files per pet is stored in the ESP32 (2) firmware settings. Multiple audio files may be used per pet, with each activation incrementing the file index; playback loops to the first file once the maximum count is reached. Additional audio files may be triggered when closing the aperture at the end of a session, opening both apertures for refilling, or as a reminder if an aperture remains open beyond a specified time period. Although this embodiment stores the microSD card internally within the DFPlayer Mini module, alternative embodiments may include a ribbon cable to extend a microSD or full-sized SD card slot to the exterior of the cover (22) for user access.

The LCD module's backlight, the LED module, and the audio module may be scheduled to deactivate during designated sleeping hours. If the audio module is required for accessibility features, its volume may be decreased during sleeping hours and increased during daytime hours. Volume adjustments and 7-segment LED brightness levels may be automated based on local time, user preferences, or ambient light sensor input in alternative embodiments.

### Inputs

The TM1638 7-segment LED module's eight push buttons/momentary switches (4b) can be programmed for a variety of functions, including but not limited to:
Button 1—First Press
   Opens left cover, then right cover (sequenced to reduce power draw)
   Flashes LED 1 (4c)
   Displays PRESS S1 on the LED display (4a)·
   Displays *PRESS S1 TO CLOSE* on LCD module (5), status line 3
   Optionally triggers a repeating audible reminder via audio module and speaker (6 and 7)
Button 1—Second Press
   Closes left cover, then right cover
   Clears indicators on LED, 7-segment display, and LCD
Button 2
   Changes display mode of the 7-segment LED module (4a)
   Displays current output mode on LCD module (5), status line 3
Button 3—Depressed
   Begins opening aperture 2 (pet's right, user's left; 14b)
   Used for manual adjustments or post-reset closure
Button 3—Released
   Stops opening aperture 2°
Button 4—Depressed
   Begins closing aperture 2 (manual adjustment)
Button 4—Released
   Stops closing aperture 2
Button 5—Depressed®
   Begins opening aperture 1 (pet's left, user's right; 14a) Used for manual adjustments or post-reset closure
Button 5—Released
   Stops opening aperture 1
Button 6—Depressed
   Begins closing aperture 1 (manual adjustment)
Button 6—Released®
   Stops closing aperture 1
Button 7
   Increases 7—segment LED brightness (4a) and 8 indicator LEDs (4c
   Each press increments brightness level (0 to 7)
   Level temporarily shown in first digit of LED display
   Also shown on LCD module (5), status line 3
   On eighth press, brightness loops from 7 (brightest) to 0 (dimmest)
   Used for diagnostic/testing during design, assembly, and system validation
Button 8
   Forces a tare of the scale (sets current raw weight to 0 grams)
   Lights LED 8 until tare is complete.

Each button press lights its corresponding LED (4c), providing immediate visual feedback.

In addition to the TM1638 module's eight LEDs (4c), an onboard LED exists on the ESP32 (2), which may display debugging information including, but not limited to:
Flashing patterns to indicate the current mode of the 7-segment display (4a)
Activation when holding down a momentary switch or push button (4c)
Indication of taring in progress
Slow flashing during aperture opening
Fast flashing during aperture closing

This internal LED may also be wired to an external LED via GPIO pin 2 for enhanced visibility.

Additional inputs are available with toggle switches. In this embodiment, there are two. The leftmost toggle switch (8) is Open/close all apertures, wired to ESP32 (2) GPIO pin 27:
Up position
   Opens aperture 1 (14a), then aperture 2 (14b), performed sequentially for power management
   Flashes LED 1 (4c)
   Displays FLIP SW on the LED display (4a)
   Displays FLIP SWITCH TO CLOSE on LCD module (5), status line 3
   Optionally triggers a repeating audible reminder via audio module and speaker (6 and 7)
Down position
   Closes aperture 1, then aperture 2
   Clears indicators on LED, 7-segment display, and LCD

The rightmost toggle switch (9) is ESP32 reset, wired to ESP32 (2) GPIO pin EN:
Up position
   Freezes all processing on the ESP32, preventing any aperture changes or display updates
Down position
   Resets the ESP32 module and restarts its firmware boot sequence

Additional embodiments may incorporate a momentary toggle switch or push button for reset, or connect additional switches to GPIO pins to enable commonly used features—serving as alternatives to other input methods.

Upon initial power-up, if preprogrammed with local Wi-Fi credentials, the ESP32 (2) firmware may optionally make itself discoverable to Amazon Echo devices. Using existing ESP32 development libraries, it emulates a standard on/off device. If enabled, this allows the user to open or close the feeding apertures via voice commands issued to their Amazon Echo devices.

### Data Recording

In this embodiment, two comma-separated value (CSV) log files are stored in the ESP32 (2) built-in storage, configured to record the weights and feeding durations of two cats. The primary log contains the following fields:
localtime.Cat1lbs.Cat1time.Cat2lbs.Cat2time

### Example Entries:

2025-10-01 21:46:46 . . . 18.8.2:102025-10-01 23:21:20,11.5,2:19.

Column 1: The date and time when a pet starts eating, determined by the scale platform, load cells, and HX711 module (13, 1a, 1b) detecting a weight between the minimum and maximum thresholds for one of the pets. Timestamps reflect the user's local time zone. Although ISO 8601 datetime format is used in this example, alternative embodiments may use custom regional formats, including omission of seconds.

Column 2: The maximum recorded weight of the lighter pet (Cat 1 in this embodiment) during the feeding session, logged in tenths of pounds. Alternative embodiments may log the mean or median weight instead, or use different units such as tenths of kilograms, grams, or—for very small animals-tenths of ounces or grams. The number of significant digits (tenths, hundredths, etc.) may also be adjusted per embodiment.

Column 3: The elapsed time from initial detection of the lighter pet to the absence of any pets, displayed in minutes and seconds.

Column 4: The maximum recorded weight of the heavier pet (Cat 2 in this embodiment) during the feeding session, in tenths of pounds.

Column 5: The elapsed time from initial detection of the heavier pet to the absence of any pets, displayed in minutes and seconds.

The secondary log, used for diagnostic purposes, contains the following fields:
localtime.Cat1lbs.Cat2lbs

Example entries:
2025-10-1 21:44:36 . . . 18.72025-10-01 23:19:01,11.4.

Column 1: The date and time when a pet starts eating, determined using the same weight threshold logic and timestamp format as described in the primary log.

Column 2: The initial recorded weight of the lighter pet (Cat 1 in this embodiment) at the start of the feeding session, logged in tenths of pounds. Alternative embodiments may log different units such as tenths of kilograms, grams, or—for very small animals—tenths of ounces or grams. The number of significant digits (tenths, hundredths, etc.) may also be adjusted per embodiment.

Column 3: The initial recorded weight of the heavier pet (Cat 2 in this embodiment) at the start of the feeding session, in tenths of pounds.

Configuration data—such as Wi-Fi credentials, display preferences, feeding thresholds, audio settings, and over-the-air (OTA) firmware update passwords—may be stored in non-volatile storage (NVS) to preserve user settings across reboots and firmware updates.

### External Access

The log files are viewable via either a built-in web server, a built-in Telnet server, or a built-in FTP server. The connection string (hostname) may be provided on a sticker by the manufacturer, or the IP address can be determined by pressing button 2 (4b) until the address is displayed. If the IP address exceeds 8 characters, it will scroll across the 7-segment LED display (4a); alternative embodiments may use the LCD module (5) for clearer display. A serial port also exists for factory calibration and firmware updates.

### Web Interface

The web interface includes, but is not limited to, emulations of the LCD and 7-segment LED displays, access to both log files, control buttons, and additional visualizations such as graphs derived from the log data. These graphical elements may be implemented using scalable vector graphics (SVG) or other rendering methods to enhance data readability and user interaction. These elements may be presented on a unified main page or distributed across separate pages. Controls include, but are not limited to:
Buttons to open and close the apertures for refilling the food bowls (29a, 29b).
A mode select button.
A dropdown list to directly select a 7-segment LED display mode, rather than cycling through modes via button.
A button to tare the scales.
Hyperlinks to download the log files.

Any or all of the eight existing TM1638 buttons (4b) may be emulated via the web interface. Optional additional sections and pages may be added, such as diagnostic data normally sent via the ESP32 (2) USB interface, or additional features including firmware update tools, feeding history visualizations, or configuration settings.

### Telnet Interface

The Telnet interface allows plaintext viewing and control, including access to log files. Upon connection, diagnostic data normally sent via the ESP32 (2) USB interface may be displayed. Supported Telnet commands include, but are not limited to:
help—List available commands
Outputs a list of all supported serial commands and their descriptions.
backlight <off/on>—LCD backlight
Turns backlight of LCD module (5) on or off.
cat </file>—Display contents of saved file
Outputs a log file stored in ESP32 (2) storage to the screen.
csv1—Display contents of debugging log file
Outputs the log file/log.csv to the screen.
csv2—Display contents of main log file
Outputs the log file/log2.csv to the screen.
dir—List files
Displays a list of files stored in ESP32 storage, along with their file sizes in bytes.
last <folder> <track>—Set last audio clip played
Changes the last audio track number played by the DFPlayer Mini (6) and speaker (7) for the specified folder. The next playback for that folder/category will increment by 1, or if the last track was entered, loop back to track 1.
play <folder> <track>—Play audio clip
Plays the specified audio track in the specified folder through the speaker.
volume [0-30]—Display/set volume
Sets the volume of the DFPlayer Mini output if a value is entered; displays the current volume if no value us entered.
reboot—Reboot the system
Performs a soft reset of the firmware. All volatile states are cleared; persistent settings remain intact.
rename </old> </new>—Rename saved file
Renames a log file stored in ESP32 storage; used for archiving log files. Reboot after renaming to recreate a new blank log file.
scan—Scan I²C bus
Scans the ESP32 Inter-Integrated Circuit (I²C) bus on GPIO pins 21 (Serial Data, SDA) and 22 (Serial Clock, SCL); returns hexadecimal values of detected devices.
temp—Display RTC temperature
Displays the temperature detected by the DS3231 real-time clock (RTC) module (10), rounded to the nearest quarter degree Celsius and to the nearest half degree Fahrenheit.
time—Display ESP32/RTC time
Displays the ESP32 internal clock in local time zone, and the DS3231 RTC time in UTC. (Local time zone is configured in firmware; RTC is set in UTC to avoid daylight saving time issues.)
ntp—Sets RTC and ESP32 to NTP time
Uses the Wi-Fi connection to connect to a Network Time Protocol (NTP) service configured in firmware. The current embodiment uses pool.ntp.org. Once the server is reached and current time is received with fractions of a second, the ESP32 clock is set to the fractional second. The firmware then waits until the next second is reached before setting the RTC to the current time, thereby ensuring the RTC is as accurate as possible.
exit—Log out
Logs out of and disconnects the Telnet session.
Ctrl+C—Abort
Immediately disconnects the Telnet session.

In web or Telnet-based interfaces, additional expressive feedback may be provided, including symbolic overlays, visual status indicators, or custom glyphs.

### Serial Interface

In this embodiment, the serial interface is a USB port located on the ESP32 module (2). Accessing this interface requires removal of the electronics cover (22), disconnection of the ESP32 from the internal power supply (18) and backup battery (19), and attachment of a USB cable from the ESP32 to an external computer. This interface also serves as the primary method for performing firmware updates, including initial flashing and future upgrades.

Alternate embodiments—such as development or industrial units—may include an additional external USB connection (20) and a switch that routes the ESP32's USB port to either the power USB connection or the serial USB interface. These embodiments may also power the ESP32 via its 5V and GND pins, with diodes added to prevent backflow of current from the powered ESP32 into the connected computer, thereby eliminating the need for a mechanical A/B USB switch.

Serial commands include, but are not limited to:
t—Tare the scale
Resets the current weight reading to zero. Used before feeding sessions or calibration.
r—Reboot the system
Performs a soft reset of the firmware. All volatile states are cleared; persistent settings remain intact.
p—Activate plotter mode
Sends raw HX711 values continuously through serial output. Useful for debugging or visualizing weight changes in real time.
n.n—Set scale factor to n.n
Adjusts the calibration multiplier for the scale. Higher values increase sensitivity; lower values reduce it.
n.n—Set left: right servo ratio to +1: +n.n
Slows down the right servo to match the left. Used to compensate for mechanical or manufacturing variance between MG996Rs.
?—List available commands
Outputs a list of all supported serial commands and their descriptions.

Additional commands may be defined in future embodiments to support extended calibration, diagnostics, or configuration routines. These may include commands for saving calibration data to non-volatile storage (NVS), enabling factory reset modes, or querying system status.

Future embodiments may support over-the-air (OTA) firmware updates via Wi-Fi or Bluetooth. However, the USB serial interface remains the primary method in this embodiment, and will serve as a backup method in most embodiments, as it is currently the only update pathway that continues to function even if the firmware fails to connect to Wi-Fi or accept OTA update requests-such as in cases of firmware corruption or connectivity failure that would otherwise render the device inoperable.

1. A system comprising a scale, one or more covers, one or more food containers, and a processor configured to measure the weight of an animal on the scale and to open the appropriate cover(s) based on the measured weight.

2. The system of claim 1, wherein the system comprises a high-torque servo and a custom gear assembly configured to actuate a large-diameter aperture ring, wherein the aperture is fully opened within approximately 1.6 seconds.

3. The system of claim 1, wherein each gear opening and closing the cover is a torque-limiting gear operatively coupled to the motor, configured to provide sufficient traction to open and close the food covers, while permitting free movement beyond the fully-open state to enable calibration and prevent stalling, and further configured to prevent injury to a cover or an animal during closure via deformation, slippage, or other torque-limiting behavior such as spring-loaded extensions, flexible inserts, or concentric rings.

4. The system of claim 3, wherein each torque-limiting gear comprises a plurality of shims configured to form traction points that enable torque transfer while permitting controlled overspinning.

5. The system of claim 1, wherein the measured weight of each animal is saved for later retrieval.

6. The system of claim 1, wherein the measured weight of each animal is displayed in real time during feeding.

7. The system of claim 1, wherein the last recorded measured weight of each animal is displayed.

8. The system of claim 1, wherein identification includes measuring pet height, width, and/or depth using photoelectric sensors.

9. The system of claim 1, wherein identification includes detecting surface reflectivity and fur coloration using optical sensors.

10. A system comprising a processor configured to identify an animal and to deliver individualized audio feedback corresponding to the identified animal.

11. A system comprising a processor configured to detect the presence of an animal at a feeding station, determine the duration of feeding, and store feeding end time and/or feeding duration for each animal for later retrieval.
